(19) United States
(12) Patent Application Publication
(10) Pub. No.: US 2011/0186007 A1
(43) Pub. Date: Aug. 4, 2011

(54) Method For Operating A Self-Compressing Aircraft Engine

(75) Inventor: Erik Bollen, Hamburg (DE)

(73) Assignee: THIELERT AIRCRAFT ENGINES GMBH, Lichtenstein (DE)

(21) Appl. No.: 13/122,567

(22) PCT Filed: Aug. 6, 2009
(86) PCT No.: PCT/EP09/60234

§ 371 Date: Apr. 20, 2011

(30) Foreign Application Priority Data
Oct. 16, 2008 (DE) 102008042915.5

(51) Int. Cl. F02B 3/00

(52) U.S. Cl. 123/299

(57) ABSTRACT

Diesel engines are proposed as the drive unit for aircrafts that operate reliably and trouble-free even at great altitudes, wherein the combustion in the diesel engines at top dead center is moved up to an earlier point in time according to the flight altitude and the corresponding barometric pressure. In addition, the charge pressure may be set to a constant value, which is not dependent on the flight altitude, and furthermore, the quantity of fuel supplied may be adjusted to a minimum fuel quantity adjusted to the respective charge pressure.

### TECHNICAL FIELD

The invention relates to a method for operating a self-compressing aircraft engine, in particular an aircraft diesel piston engine, which is operated at a specific boost pressure of the combustion air introduced into a cylinder, and with a pilot and primary fuel injection at the top dead center.

### BACKGROUND

The principle underlying the diesel piston engine involves the self-ignition of the fuel injected into the cylinder, which is highly compressed and therefore hot. When injecting the fuel into the combustion chamber before the top dead center of the piston, the air compression, and hence temperature, is so high that the injected fuel can evaporate, and the vapor-air mixture can ignite. However, power decreases with increasing altitude in aircraft diesel engines, specifically due to a reduction in air pressure and air density, and the lower compression and temperature of the air in the combustion chamber associated therewith. Given an insufficient compression, and correspondingly an inadequate temperature, of the compressed air, for example when the cruising altitude and power of the self-compressing engine are reduced, meaning at low power settings at a high altitude, self-ignition can be sparked, and the engine can cut out.

### SUMMARY OF THE INVENTION

Therefore, the object of the invention is to indicate a method for controlling an aircraft diesel piston engine, which maintains smooth engine operation at low loads, even at higher altitudes.

According to the invention, the object is achieved with a method for operating a self-compressing aircraft engine, in particular an aircraft diesel piston engine, which is operated at a specific boost pressure of the combustion air introduced into a cylinder, and with a pilot and primary fuel injection at the top dead center, wherein the injection time for injecting the fuel into the compressed combustion air, and hence the timeframe for fuel combustion, is shifted forward to an earlier point as cruising altitude rises; and/or wherein the supply of a minimal quantity of fuel corresponding to the respective boost pressure is regulated as a function of the level of the boost pressure that decreases as cruising altitude increases, or the boost pressure is readjusted as a function of the respective cruising altitude to a preset, constant desired boost pressure and a minimal quantity of supplied fuel. Additional features and advantageous further developments of the invention are discussed further below.

### DETAILED DESCRIPTION OF THE INVENTION

In a first important feature, the core of the invention lies in the fact that the initiation of fuel injection, and hence ignition and combustion of the fuel, is shifted to an earlier point in time as a function of the respective cruising altitude, so that a higher amount of heat is generated at a higher altitude, maintaining the ignition and combustion even at a diminished air pressure at a high altitude, and hence a reduced compression of the combustion air.

The fuel injection shifted forward in time here encompasses a pilot injection and primary injection. This means that the engine is controlled in such a way as to shift the entire injection packet forward in time with increasing altitude. In addition, the time interval between the pilot injection and primary injection is adjusted as cruising altitude rises, so as to in this way generate more lost energy, and hence more heat, and further improve the ignition behavior of the engine at a higher cruising altitude, specifically without exerting a greater influence on the engine power imparted to the propeller.

In another important feature of the invention, the altitude-dependent air pressure and boost pressure of the engine are measured, and a required minimal quantity of fuel to be supplied to the engine for maintaining engine operation is determined as a function of the ascertained values. As a result, a defined minimum quantity of fuel is always available for smooth engine operation.

In yet another important feature of the invention, the altitude-dependent barometric pressure and boost pressure of the self-compressing engine are ascertained, and the boost pressure is readjusted to a specific desired value based on the respective air pressure, so as to ensure a stable combustion and minimal possible power of the propulsion system.

In another embodiment of the invention, the power set by the pilot and engine parameters like speed, air and water temperature along with fuel quantity, boost pressure and finally air pressure are measured and analyzed in corresponding evaluators, so as to be able, based thereupon, to calculate the altitude-dependent setting of the injection and combustion timeframe, and minimal fuel quantity, depending on the respective boost pressure or a constant boost pressure independent of the respective altitude.

The method according to the invention makes it possible to use diesel engines, which can also be operated with the jet fuel available worldwide, as aircraft engines that operate reliably and smoothly even at higher altitudes. The aircraft equipped with a self-compressing engine controlled according to the invention ca also fly at higher altitudes at a lower power level, without the engine cutting out. The pilot has a wider available operating range, and a power reduction owing to diminished compression (power settings) at a specific altitude is precluded.

An exemplary embodiment of the invention will be described below.

In an aircraft powered by a diesel engine that can also be used at higher altitudes, the speed of the engine and the air pressure corresponding to the cruising altitude as well as the boost pressure are ascertained in addition to the power entered by the pilot. Based on the necessary boost pressure calculated according to the desired power and respective air pressure, and on a comparison with the measured boost pressure, a PID computer is used to actuate a boost pressure control valve, and the boost pressure is readjusted to a value tailored to the respective cruising altitude.

After the speed and power have been ascertained and a base fuel quantity has been determined, and based upon a measurement of the air pressure boost pressure, and a minimum fuel quantity calculated from the latter corresponding to the boost pressure based on the respective cruising altitude, an injection module can be actuated in a similar way, so as to inject a minimal quantity of fuel into the cylinder at each boost pressure.

1. A method for operating a self-compressing aircraft diesel piston engine comprising:
operating the aircraft engine at a specific boost pressure of the combustion air introduced into a cylinder, and performing a pilot and primary fuel injection at a top dead center of a piston therein, shifting forward the injection time for injecting the fuel into the compressed combustion air, and hence the timeframe for fuel combustion, to an earlier point as cruising altitude rises; and/or wherein a supply of a minimal quantity of fuel corresponding to the respective boost pressure is regulated as a function of the level of the boost pressure that decreases as cruising altitude increases, or the boost pressure is readjusted as a function of the respective cruising altitude to a preset, constant desired boost pressure and a minimal quantity of supplied fuel.

2. The method of claim 1, wherein the time of the pilot and primary fuel injection is shifted forward in time as a packet.

3. The method of claim 1, wherein the time interval between the pilot injection and primary injection of fuel is adjusted as cruising altitude rises.

4. The method of claim 1, wherein the initiation of combustion is shifted forward to a time before the top dead center of the piston in the cylinder is reached.

5. The method of claim 1, further comprising acquiring engine parameters selected from the group consisting of speed, power, boost pressure, fuel quantity, air temperature and water temperature, and processing the engine parameters in an evaluator unit in order to set the injection and combustion start, as well as the time interval between the pilot and primary injection and a constant boost pressure or the fuel quantity.

6. The method of claim 2, wherein the time interval between the pilot injection and primary injection of fuel is adjusted as cruising altitude rises.

7. The method of claim 2, wherein the initiation of combustion is shifted forward to a time before the top dead center of the piston in the cylinder is reached.

8. The method of claim 3, wherein the initiation of combustion is shifted forward to a time before the top dead center of the piston in the cylinder is reached.

9. The method of claim 2, further comprising acquiring engine parameters selected from the group consisting of speed, power, boost pressure, fuel quantity, air temperature and water temperature, and processing the engine parameters in an evaluator unit in order to set the injection and combustion start, as well as the time interval between the pilot and primary injection and a constant boost pressure or the fuel quantity.

10. The method of claim 3, further comprising acquiring engine parameters selected from the group consisting of speed, power, boost pressure, fuel quantity, air temperature and water temperature, and processing the engine parameters in an evaluator unit in order to set the injection and combustion start, as well as the time interval between the pilot and primary injection and a constant boost pressure or the fuel quantity.

11. The method of claim 4, further comprising acquiring engine parameters selected from the group consisting of speed, power, boost pressure, fuel quantity, air temperature and water temperature, and processing the engine parameters in an evaluator unit in order to set the injection and combustion start, as well as the time interval between the pilot and primary injection and a constant boost pressure or the fuel quantity.
